(19) United States
(12) Patent Application Publication
(10) Pub. No.: US 2010/0071218 A1
(43) Pub. Date: Mar. 25, 2010

(54) SWITCH-OPERATING MECHANISM

(76) Inventors: Richard POOLE, Suffolk (GB); Nicholas BUTCHER, Ipswich (GB)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/547,364

(22) Filed: Aug. 25, 2009

(30) Foreign Application Priority Data
Aug. 26, 2008 (EP) 08105138.5

(51) Int. Cl. B26B 15/00; H01H 3/04

(52) U.S. Cl. 30/233; 200/335

(57) ABSTRACT

The present invention relates to a switch-operating mechanism. In particular, the present invention relates to a switch-operating mechanism for a power tool, such as a pruning tool. Described is a switch-operating mechanism for a powered tool including a working head having first and second cutter members. The switch-operating mechanism further includes a lever moveable between first, second, and third operative positions. In operation, positioning of the lever in the first operative position provides a ‘power off mode’ in which the power supply is disconnected; movement of the lever into the second operative position causes the at least one of the cutter members to move to a first blade position; and movement of the lever into the third operative position causes the at least one of the cutter members to move to a second blade position.

### CROSS REFERENCE TO RELATED APPLICATIONS

This application is based on EP Application No. 08105138.5 field on Aug. 26, 2008.

### BACKGROUND OF THE INVENTION

1. Field of the Invention

The present invention relates to a switch-operating mechanism. In particular; the present invention relates to a switch-operating mechanism for a powered cutting tool, such as a vegetation cutting tool, more particularly such as a pruning tool.

2. Description of the Prior Art

Pruning tools in the form of secateurs are well known for use in cutting plant stems and trees and shrub branches. There are three basic types of secateur: “anvil”, which comprise a single blade that can be moved against a flat surface to cut a stem; “bypass”, which usually comprise a pair of blades (often just one of the blades has a cutting surface) that are operated like a pair of scissors, and which provide a shearing force to cut the stem as the blades are moved passed each other; and “parrot-beak”, which are also operable like a pair of scissors and which comprise a pair of concave blades, between which a stem can be trapped and cut.

Pruning tools may be manually operated or driven, usually by an electrical motor. For example, EP 803187 A2 describes a set of pruning shears which have two relatively adjustable cutting blades, one of which is secured to the housing of the shears, the other operated by an electric motor.

DE 19849976 A1 also describes a set of motor driven shears having a fixed blade and a moveable blade. The moveable blade is coupled swivellable with the fixed blade such that it can carry out a cutting operation in conjunction with the fixed blade. Movement of the blade is controlled by an electric motor which is coupled to a control unit and sensor to detect when the blade is at the predetermined extremes of operation.

Powered pruning tools usually include a 2-position switch which is readily actuatable by the user to cause the blades to move between open and closed positions. In such powered pruning tools, a secondary switch is typically provided to de-energize the tool so as to avoid the risk of the blades being actuated inadvertently.

This can take the form of an independent on/off switch located separately on the tool. For example, EP 0291431 A1 describes a portable electric tool, such as a pair of secateurs, that include a trigger which protrudes from the tool housing and operates an electric control device. The trigger and the electric control device are connected to a moving gear unit of a moving working component and follow the movements of the component. The trigger and the control device can occupy different relative positions, so that each movement made by the trigger from a neutral position causes activation of the control device, which in turn starts an electric motor to move the whole unit—wherein the whole unit comprises the moving gear unit, the trigger, and the control device—which then returns automatically to the neutral position at which the trigger is immobilized either by limit stops, or manually.

However, this kind of switch arrangement encourages the user to leave the tool in a ‘switched-on’ condition and so does not reliably prevent the tool from being inadvertently operated. This may also result in an undesirable drain on the power source.

Other switch mechanisms comprising a second finger switch are also known. For example, DE 19849976 A1 describes a pair of motor operated shears comprising two finger-operated switches. In this switch arrangement, the first switch is moveable between two positions to select blade motion towards closed or open positions. Simultaneous actuation of the second finger switch is necessary to enable the motor to operate.

However, these kind of switches can be inadvertently actuated simply when holding the tool in its normal operating position.

Accordingly, the present invention seeks to overcome at least some of these disadvantages and provide a switch-operation mechanism which facilitates safer use of a powered cutting tool.

### SUMMARY OF THE INVENTION

In a first aspect of the present invention there is provided a switch-operating mechanism for a powered cutting tool including a working head having first and second cutter members. The switch-operating mechanism further includes a lever moveable between first, second and third operative positions. Positioning of the lever in the first operative position provides a ‘power off mode’ in which the power supply is disconnected, movement of the lever into the second operative position causes at least one of the cutter members to move to a first blade position, and movement of the lever into the third operative position causes the at least one cutter member to move to a second blade position.

Preferably, the lever abuts longitudinally against a housing of the cutting tool, when in the first operative position, whereby the normal operation of the lever is restricted.

Preferably, the lever is operatively-biased towards the first position by a first biasing element. Preferably, the first biasing element is a spring.

Optionally, the lever includes a second biasing element which is activated in response to the lever being moved, in use, between the second and third positions. Suitably, activation of the second biasing element increases a force required to operate the lever to between 15% and 60% greater than that required to overcome the first biasing element; preferably between 25% and 40% greater; more preferably about 30% greater. Preferably, the second biasing element is a spring.

Preferably, the switch-operating mechanism further comprises an interlock to lock the switch lever in the first position for storage.

Preferably, the switch-operating mechanism includes a switch lever guard.

Suitably, the switch-operating mechanism further comprises one or more lever-position-detection switches. Preferably, the lever-position-detection switches act to control the power supply to the working head.

In a second aspect there is provided a power tool comprising a switch-operating mechanism as described above.

Preferably, the power tool is a cutting tool; more preferably a pruning tool. Suitably, the pruning tool is motor driven and comprises a body, motor unit and a cutting head operable by means of the switch-operating mechanism.

Preferably, the motor is a direct current motor.

Preferably, the power tool is battery-powered. Preferably, the battery is rechargeable; more preferably, the battery is a lithium-ion battery.

Preferably, the cutting tool comprises first and second cutter members having respective cutting surfaces, wherein the first cutter member is pivotably mounted with respect to the second cutter member, and wherein at least the first cutter member is moveable between a first position with respect to the second cutter member, in which a space is formed between the respective cutting surfaces, and a second position with respect to the second cutter member, in which the space between the respective cutting surfaces is closed.

Preferably, the first cutter member is a moveable blade and the second cutter member comprises a fixed blade. Preferably, the fixed blade further comprises a vegetation guide.

Preferably, the lever provides a non-continuous activation of the motor, in use.

Suitably, the pruning tool further comprises one or more blade position-limit switches. At least one blade position-limit interrupts the supply of power to the motor when at least one moveable member of the working head has moved from a first position in which the first cutter member is in the first angular position with respect to the second cutter member, to a second position in which the first cutter member is in the second angular position with respect to the second cutter member, in use. Preferably, the one or more limit switches provide a short-circuit across the motor connections when the at least one cutter member has moved from first to second angular positions.

Optionally, the pruning tool further includes battery cell monitoring circuits. In preferred embodiments, control electronics for the motor and or limit switch operations also incorporate lithium-ion battery monitoring and controlling functions. For example, it may be desired to disable operation of the motor in the event that the battery becomes discharged below a pre-selected voltage or its temperature exceeds a predefined limit.

### BRIEF DESCRIPTION OF THE DRAWINGS

The above and other aspects of the present invention will now be illustrated in further detail, by way of example only, with reference to the accompanying drawings in which:

FIG. 1 is a perspective view of an embodiment of a pruning tool in accordance with the second aspect of the invention;

FIG. 2 is a side view of the embodiment of FIG. 1;

FIG. 3 is a perspective view of the principal components of the switch-operating mechanism of the embodiment of FIG. 1, in which the switch lever is in a first position;

FIG. 4 is a perspective view of the principal components of the switch-operating mechanism of the embodiment of FIG. 1, in which the switch lever is in a second position; and

FIG. 5 is a perspective view of the principal components of the switch-operating mechanism of the embodiment of FIG. 1, in which the switch lever is in a third position.

### DESCRIPTION OF THE PREFERRED EMBODIMENTS

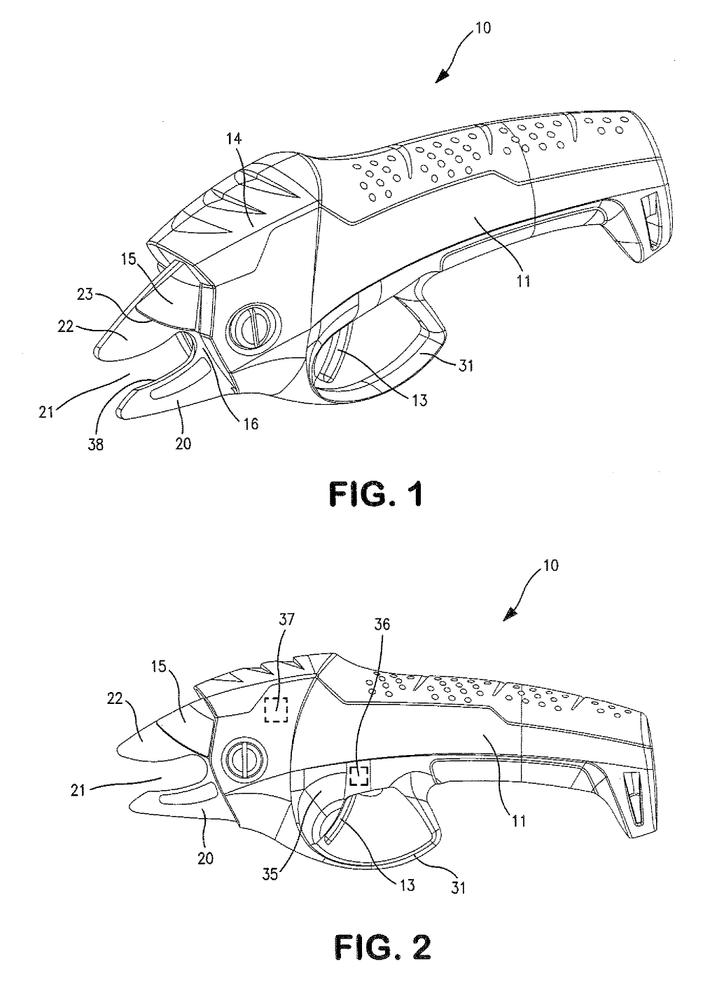

Referring to FIGS. 1 and 2, there is shown a pruning tool 10 generally of the bypass type and comprising an elongate handle 11, the handle including a user-control in the form of a switch lever 13. Handle 11 further includes a cutting head 14 located at a front end of handle 11, the cutting head 14 comprising a moveable blade or cutter member 15 and a fixed cutting head element in the form of plate 16. Plate 16 comprises a fixed blade or cutter member 20 with unsharpened leading edge 38 and a vegetation guide 22 forming a vegetation-receiving channel 21 therebetween. Handle 11 and cutting head 14 comprise portions of a tool housing 35 which houses a motor and a battery power source (not shown).

Moveable cutter member 15 includes a sharpened leading or cutting edge 23 and is pivotally drivable, in use, between retracted and extended positions by a motor. When the moveable cutter member 15 is in the retracted position, moveable and fixed cutter members 15, 20 are operatively spaced, and the sharpened leading edge is retracted and protected by vegetation guide 22, and vegetation-receiving channel 21 is open.

In use, the action of driving moveable cutter member 15 towards the fixed cutter member 20 provides a shearing action therebetween in the manner of a bypass-type pruner. That shearing action can be used to cut any vegetation which has been located within the vegetation-receiving channel 21. In alternative embodiments, the action of driving the moveable cutter member 15 towards the fixed cutter member 20 provides a simple cutting force therebetween, in which a sharpened leading edge of the moveable cutter member 15 forces the article to be but against the fixed cutter member 20 to thereby cut the article in the manner of an anvil-type pruner.

In the illustrated embodiment, the fixed cutter member 20 is not moveable. However, in alternative embodiments (not shown) second cutter member 20 is reciprocally drivable relative to the moveable cutter member 15.

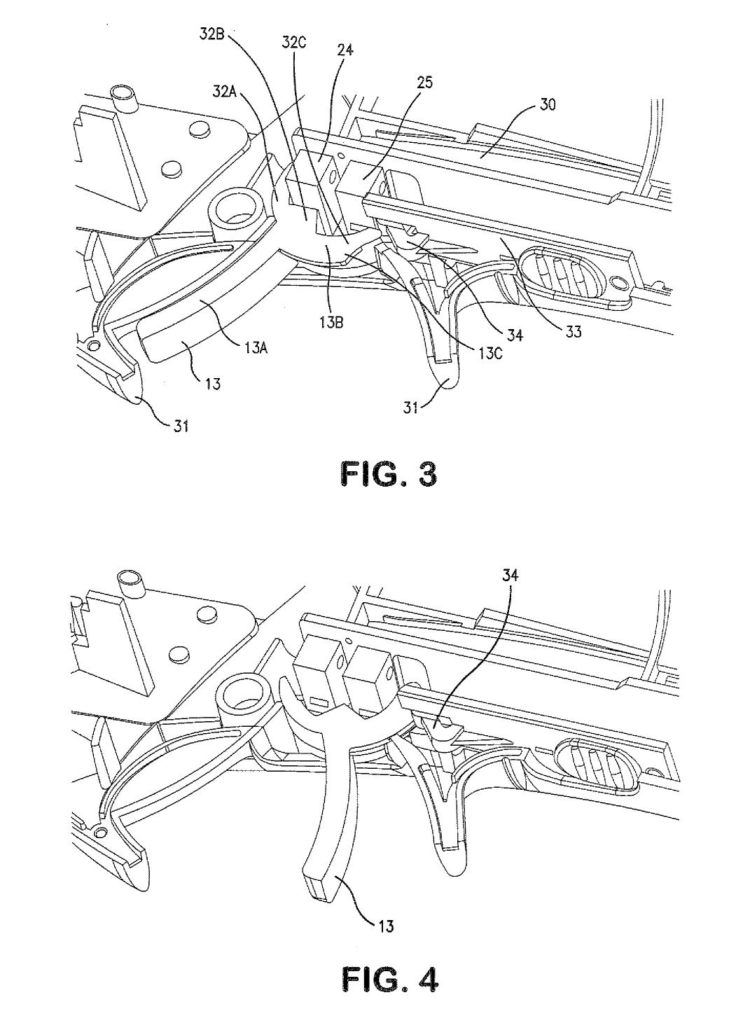

Referring now to FIGS. 3 to 5, there is shown the principal components of a switch-operating mechanism in which the upper half of the tool housing has been omitted for clarity. The switch-operating mechanism comprises a trigger or switch lever 13, lever-position-detection switches in the form of micro-switches 24, 25, and a circuit board 30, upon which the micro-switches 24, 25 are mounted.

Switch lever 13 comprises an elongate arm 13A and a hand 13B which includes three fingers 32A, 32B, 32C and is pivotably mounted within the pruning tool housing. As will be described in more detail below, in the assembled mechanism, finger 32B operatively engages with micro-switches 24, 25 to determine in which of three operating positions A, B, C is switch lever 13.

In the illustrated embodiment, the pruning tool also includes a lever guard 31 which acts to shield the switch lever 13 from inadvertent activation. In particular, the lever guard 31 acts to prevent branches from engaging with the switch lever or the fingers of a user's hand to inadvertently affect operation of the pruning tool. In FIGS. 3 to 5 a portion of the continuous guard has been omitted for clarity.

In FIG. 3, the switch lever 13 is in position ‘A’, and is sprung-loaded by a first biasing means in the faun of a torsion spring 36 (shown schematically in FIG. 2) against the housing of the tool. Accordingly, and as shown in FIGS. 1 to 3, access to the switch lever 13, and thus its normal operation, is restricted to prevent the inadvertent activation of the pruning tool. In this condition, a first face of the lever finger 32B is in contact with microswitch 24 which results in the de-energisation of all electrical circuits within the tool (including cell condition monitoring etc.). The tool can therefore be left unattended for long periods when not in use without loss of battery charge.

Also shown is a slidable manual lock 33. The slidable lock 33 is slidably moveable 15 between disengaged and engaged positions, and when in an engaged position, as shown in FIG. 3, the lock mechanically prevents the movement of the switch lever 13 from position A. This provides an additional security against unintended operation.

FIG. 4 shows the switch lever 13 in position ‘B’. In operation of the switch lever 13, a user's finger has rotated the switch lever 13 away from the housing by levering against its sidefaces whilst overcoming the preload provided by the spring 36. In rotating the lever switch to position B, contact between microswitch 24 and finger 32B is lost. This has the effect of simultaneously energizing all of the battery cell condition monitoring circuits and energizing the motor to drive the moveable cutter member 15 of the cutting head 14 to the retracted position (if it were not already in the retracted position).

The pruning tool also includes blade position detecting limit switches 37 (shown schematically in FIG. 2) to stop the motor drive when the moveable blade is in the correct fully retracted position.

In addition, battery cell monitoring circuits are required when lithium-ion cells are used. The switch-operating mechanism optionally also includes battery cell monitoring circuits. In preferred embodiments, control electronics for the motor and or limit switch operations also incorporate lithium-ion battery monitoring and controlling functions. For example, it may be desired to disable operation of the motor in the event that the battery becomes discharged below a pre-selected voltage or its temperature exceeds a predefined limit.

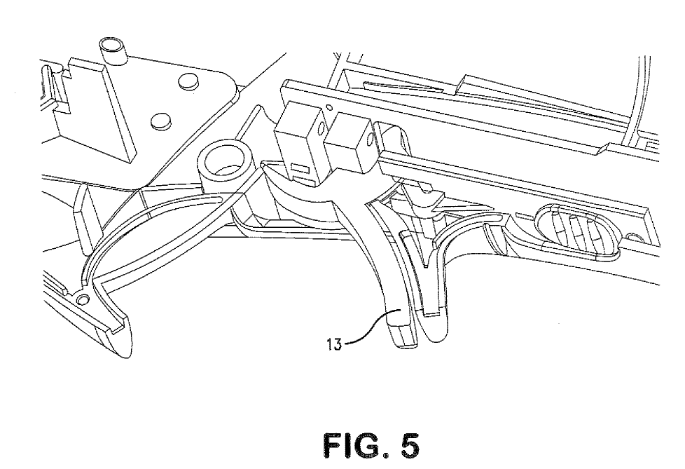

FIG. 5 shows switch lever 13 in position ‘C’. In further operation of the switch lever 13, a user's finger has rotated the switch lever 13 in the manner of a trigger action to position C. In rotating the lever switch to position C, the loss of contact between microswitch 24 and the first face of finger 32B is maintained, whilst contact between a second face of finger 32B and microswitch 25 is made. This has the effect of maintaining the battery cell condition monitoring circuits in an energised state and energises the motor to drive the moveable blade 15 of the cutting head 14 to the extended position, in which moveable blade traverses vegetation-receiving channel 21. Also when in position ‘C’, finger 32A protects microswitch 24 from direct contact with the user.

The switch mechanism preferably includes a further indication means to notify the user that switch lever 13 is approaching position C. The indication means will preferably provide indications of a tactile nature. For example, the indication means will lead to an additional increase in resistance to the rotation of switch lever 13. The indication means comprises a ramp 13C, located on the switch lever 13 which cooperates with a flexible member 34 formed integrally with the slidable manual lock 33. This flexible member 34 comprises a second biasing means which is activated in response to the switch lever being moved, in use, between position B and position C. It is possible that the second biasing means is engaged as soon as the switch lever 13 is in position B, or more preferably, at an intermediate position between position B and position C (i.e., nearer to the end of the triggering stroke).

Activation of the second biasing means increases a force required to operate the switch lever 13 to between 15% and 60% greater than that required to overcome the first biasing means; preferably between 25% and 40% greater; more preferably about 30% greater.

Moveable cutter member 15 will remain in the extended position for as long as switch lever 13 is maintained in position C. However, once the switch lever 13 is returned to position B, the moveable cutter member 15 moves to the retracted position. A particular advantage of this arrangement is the ease with which a series of cuts can be made by simple one-finger movement once the distinct action of moving the switch lever 13 from position A to position B has been completed once only. After use the lever is returned to position A from position B for tool shutdown and storage. The movable cutter member 15 will therefore be in the retracted position for storage of the tool.

The foregoing relates to the preferred exemplary embodiments of the invention, it being understood that other variants and embodiments thereof are possible within the spirit and scope of the invention, the latter being defined by the appended claims.

1-15. (canceled)

16. A switch-operating mechanism for a powered cutting tool comprising a working head having first and second cutter members, the switch-operating mechanism further comprising a lever moveable between first, second, and third operative positions, wherein:
positioning of the lever in the first operative position provides a ‘power off mode’ in which the power supply is disconnected;
movement of the lever into the second operative position causes at least one of the cutter members to move to a first blade position; and
movement of the lever into the third operative position causes the at least one cutter member to move to a second blade position.

17. A switch-operating mechanism as claimed in claim 16, wherein the lever abuts longitudinally against a housing of the cutting tool, when in the first operative position, whereby the normal operation of the lever is restricted.

18. A switch-operating mechanism as claimed in claim 16, wherein the lever is operatively-biased towards the first position by a first biasing element.

19. A switch-operating mechanism as claimed in claim 17, wherein the lever is operatively-biased towards the first position by a first biasing element.

20. A switch-operating mechanism as claimed in claim 16, wherein a second biasing element is activated in response to the lever being moved, in use, between the second and third positions.

21. A switch-operating mechanism as claimed in claim 17, wherein a second biasing element is activated in response to the lever being moved, in use, between the second and third positions.

22. A switch-operating mechanism as claimed in claim 18, wherein a second biasing element is activated in response to the lever being moved, in use, between the second and third positions.

23. A switch-operating mechanism as claimed in claim 20, wherein activation of the second biasing element increases a force required to operate the lever to between 15% and 60% greater than that required to overcome the first biasing element; preferably between 25% and 40% greater; more preferably about 30% greater.

24. A switch-operating mechanism as claimed in claim 16, wherein the switch-operating mechanism further comprises an interlock to lock the lever in the first position for storage.

25. A switch-operating mechanism as claimed in claim 16, wherein the switch-operating mechanism includes a lever guard.

26. A switch-operating mechanism as claimed in claim 16, wherein the switch-operating mechanism further comprises one or more lever-position-detection switches.

27. A switch-operating mechanism as claimed in claim 26, wherein, the lever-position-detection switches act to control the power supply to the working head.

28. A power tool comprising a switch-operating mechanism as claimed in claim 16.

29. A power tool as claimed in claim 28, wherein the power tool is a power tool of the type having a non-continuous demand for power.

30. A power tool as claimed in claim 28, wherein the power tool is a cutting tool; more preferably a pruning tool.

31. A power tool as claimed in claim 28, further comprising first and second cutter members having respective cutter surfaces, wherein the first cutter member is pivotably mounted with respect to the second cutter member, and wherein at least the first cutter member is moveable between a first position with respect to the second cutter member, in which a space is formed between the respective cutting surfaces, and a second position with respect to the second cutter member, in which the space between the respective cutting surfaces is closed.

32. A power tool as claimed in claim 29, further comprising first and second cutter members having respective cutter surfaces, wherein the first cutter member is pivotably mounted with respect to the second cutter member, and wherein at least the first cutter member is moveable between a first position with respect to the second cutter member, in which a space is formed between the respective cutting surfaces, and a second position with respect to the second cutter member, in which the space between the respective cutting surfaces is closed.

33. A power tool as claimed in claim 30, further comprising first and second cutter members having respective cutter surfaces, wherein the first cutter member is pivotably mounted with respect to the second cutter member, and wherein at least the first cutter member is moveable between a first position with respect to the second cutter member, in which a space is formed between the respective cutting surfaces, and a second position with respect to the second cutter member, in which the space between the respective cutting surfaces is closed.

34. A power tool as claimed in claim 28, further comprising one or more blade position-limit switches.

35. A power tool as claimed in claim 34, wherein at least one blade position-limit interrupts the supply of power to the motor when at least one moveable member of the working head has moved from a first position in which the first cutter member is in the first angular position with respect to the second cutter member, to a second position in which the first cutter member is in the second angular position with respect to the second cutter member.
